(19) United States
(12) Patent Application Publication
(10) Pub. No.: US 2026/0101159 A1
(43) Pub. Date: Apr. 9, 2026

(54) METHODS, ARCHITECTURES, APPARATUSES, AND SYSTEMS FOR MOBILITY SUPPORT OF SENSING FOR TRACKING

(71) Applicant: InterDigital Patent Holdings, Inc., Wilmington, DE (US)

(72) Inventors: Jung Je Son, Warrington, PA (US); Magurawalage Chathura Madhusanka Sarathchandra, London (GB); Taimoor Abbas, Sainte-Julie (CA); Anuj Sethi, Ottawa (CA); Zhibi Wang, Woodridge, IL (US); Samir Ferdi, Kirkland (CA)

(21) Appl. No.: 18/906,107

(22) Filed: Oct. 3, 2024

(51) Int. Cl. H04W 4/38; H04W 4/024; H04W 24/02

(52) U.S. Cl. CPC H04W 4/38; H04W 4/024; H04W 24/02

(57) ABSTRACT

A wireless network tracks a target object using multiple sensing entities. Upon receiving a sensing service request and path information, the network identifies relevant entities and assigns them to specific groups, each associated with distinct sensing service areas. The entities are configured for sensing operations and activated based on a location of the target object. Entities in a first sensing service area are activated to collect measurements, which are then used to determine a sensing result. As the target moves to a different sensing service area, the corresponding group of entities is activated to continue tracking. The process includes updating a state of the entities and configuring them with assistance information. The entities can be wireless transmit/receive units (WTRUs) or base stations. Methods for tracking a target object using sensing entities in different service areas, and activating operations based on detected movements and results are also provided.

### TECHNICAL FIELD

The present disclosure is generally directed to the fields of communications, software and encoding, including, for example, to methods, architectures, apparatuses, systems related to a sensing task.

### BACKGROUND

The 5G network architecture includes functions, interfaces, and protocols for mobility, session, and policy management, while integrated sensing capabilities support various applications like autonomous driving and smart cities by collecting and processing data from radio signals.

### SUMMARY

In certain representative embodiments, a method performed by a wireless network comprises one or more steps. For example, the method comprises receiving a sensing service request for tracking a target object and path information. Also, for example, based on the path information, the network identifies a plurality of sensing entities. Further, for example, the network assigns one or more sensing entities to a respective group of a plurality of groups of sensing entities. In addition, for example, each sensing entity is assigned to at least one group, and each group is associated with a specific sensing service area. Moreover, for example, the network configures each sensing entity for sensing operation. Furthermore, for example, the network determines that the target object is in a first sensing service area based on the path information. Additionally, for example, based on this determination, the network activates each sensing entity in the first group associated with the first sensing service area for sensing operation. Still further, for example, the network receives first sensing measurements from the first group of sensing entities. Even further, for example, the network determines a first sensing result based on these measurements. Yet further, for example, the network determines that the target object has moved to a second sensing service area, which is different from the first. Further still, for example, based on this new determination, the network activates each sensing entity in the second group associated with the second sensing service area for sensing operation. For example, the network receives second sensing measurements from the second group of sensing entities. Also, for example, the network determines a second sensing result based on these measurements.

Also, for example, the method comprises a wireless network that comprises at least one of several functions. Further, for example, these functions may be an application function, a sensing operation management function, a sensing assistance function, or access and mobility management functions.

For example, the method comprises based on determining that the target object moved to the second sensing service area, causing each sensing entity of the first group of sensing entities to be placed in a release state. Also, for example, the method comprises causing each of the plurality of sensing entities to be configured for sensing operation by configuring each of the plurality of sensing entities based on sensing assistance information. Further, for example, the sensing assistance information comprises information indicating at least one of a sensing mechanism to be used for sensing, a waveform of a sensing signal, a resource pool, or a period of time for performing sensing measurements. In addition, for example, at least one sensing entity of the plurality of sensing entities is a wireless transmit/receive unit (WTRU). Moreover, at least one sensing entity of the plurality of sensing entities is a base station.

In certain representative embodiments, a method is performed by a WTRU in communication with a wireless network. For example, the method comprises receiving configuration information from the wireless network. Also, for example, the WTRU is associated with a sensing service area based on the configuration information. Further, for example, the WTRU enters a sensing state and is configured for sensing based on the configuration information. In addition, for example, after the WTRU enters the sensing state and is configured for sensing, it receives an activation command from the wireless network. Moreover, for example, the WTRU performs a sensing operation with respect to a target object based on the activation command. Furthermore, for example, the WTRU determines a sensing result based on the sensing operation. Additionally, for example, the WTRU transmits data indicating the sensing result to the wireless network.

In certain representative embodiments, a system implements one or more network functions of a core network of a wireless network. For example, the system comprises one or more processors configured to perform one or more steps. Also, for example, the network receives a sensing service request for tracking a target object and path information. Additionally, based on the path information, the network identifies a plurality of sensing entities. Moreover, the network assigns one or more sensing entities to a respective group of a plurality of groups of sensing entities. In addition, each sensing entity is assigned to at least one group, and each group is associated with a specific sensing service area. Furthermore, the network configures each sensing entity for sensing operation. For example, the network determines that the target object is in a first sensing service area based on the path information. Based on this determination, the network activates each sensing entity in the first group associated with the first sensing service area for sensing operation. Additionally, the network receives first sensing measurements from the first group of sensing entities. Moreover, the network determines a first sensing result based on these measurements. Further, the network determines that the target object has moved to a second sensing service area, which is different from the first. Based on this new determination, the network activates each sensing entity in the second group associated with the second sensing service area for sensing operation. Additionally, the network receives second sensing measurements from the second group of sensing entities. Finally, the network determines a second sensing result based on these measurements.

For example, the one or more network functions comprise: an application function, a sensing operation management function, a sensing assistance function, or access and mobility management functions. Also, for example, the one or more processors are further configured to, based on determining that the target object moved to the second service area, cause each sensing entity of the first group of sensing entities to be placed in a release state. Further, for example, the one or more processors are further configured to cause each of the plurality of sensing entities to be configured for sensing operation based on sensing assistance information. In addition, for example, the sensing assistance information comprises information indicating at least one of a sensing mechanism to be used for sensing, a waveform of a sensing signal, a resource pool, or a period of time for performing sensing measurements. Moreover, for example, at least one sensing entity of the plurality of sensing entities comprises a respective WTRU. Furthermore, for example, at least one sensing entity of the plurality of sensing entities comprises a respective base station. Additionally, for example, the one or more processors is further configured to perform an operation based on at least one of the first sensing result or the second sensing result.

In certain representative embodiments, a method is performed by a first sensing entity in communication with a wireless network and a second sensing entity. For example, the first sensing entity receives information from the wireless network, which causes the first sensing entity to be associated with a first sensing service area and perform a sensing operation. Additionally, the first sensing entity determines a sensing result based on the sensing operation. Moreover, the first sensing entity detects movement of a target object to a second sensing service area based on the sensing result. Furthermore, the first sensing entity causes the activation of a sensing operation at the second sensing entity at the second sensing service area based on the detected movement of the target object to the second sensing service area.

In certain representative embodiments, a first sensing entity is in communication with a wireless network and a second sensing entity. For example, the first sensing entity comprises a processor and a transceiver coupled to the processor. Additionally, the first sensing entity is configured to receive information from the wireless network, which causes the first sensing entity to be associated with a first sensing service area and perform a sensing operation. Moreover, the first sensing entity determines a sensing result based on the sensing operation. Furthermore, the first sensing entity detects movement of a target object to a second sensing service area based on the sensing result. Additionally, the first sensing entity causes the activation of a sensing operation at the second sensing entity at the second sensing service area based on the detected movement of the target object to the second sensing service area.

In certain representative embodiments, a method is performed by a wireless network in communication with a first group of sensing entities and a second group of sensing entities. For example, the method comprises receiving a sensing service request for tracking a target object and path information. Additionally, the network determines the first group of sensing entities associated with a first sensing service area based on the path information. Moreover, the network detects a change of a path of the target object by the first group of sensing entities at the first sensing service area. Furthermore, based on the change of the path, the network identifies the second group of sensing entities at a second sensing service area different from the first sensing service area. Additionally, the network updates the second group of sensing entities for tracking the target object based on the change of the path. Moreover, the network configures the second group of sensing entities for sensing operation. Furthermore, the network determines that the target object moved to the second sensing service area. Finally, the network causes the activation of the sensing operation of the second group of sensing entities at the second sensing service area.

In certain representative embodiments, a wireless network is in communication with a first group of sensing entities and a second group of sensing entities. For example, the wireless network is configured to receive a sensing service request for tracking a target object and path information. Additionally, the network determines the first group of sensing entities associated with a first sensing service area based on the path information. Moreover, the network detects a change of a path of the target object by the first group of sensing entities at the first sensing service area. Furthermore, based on the change of the path, the network identifies the second group of sensing entities at a second sensing service area different from the first sensing service area. Additionally, the network updates the second group of sensing entities for tracking the target object based on the change of the path. Moreover, the network configures the second group of sensing entities for sensing operation. Furthermore, the network determines that the target object moved to the second sensing service area. Finally, the network causes the activation of the sensing operation of the second group of sensing entities at the second sensing service area.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a reference model of a 5G/NextGen network, according to one or more embodiments;

FIG. 3 is a depiction of pedestrian and/or animal intrusion detection, according to one or more embodiments;

FIG. 4 is a depiction of intruder detection in surroundings of a smart home, according to one or more embodiments;

FIG. 5 is a table of key performance indicators (KPIs) for a sensing service, according to one or more embodiments;

FIG. 6 is an example sequence diagram for a sensing handover based on path information of a target object, according to one or more embodiments;

FIG. 7 is an example sequence diagram for a sensing handover between sensing entities, according to one or more embodiments;

FIG. 8 is an example sequence diagram for a sensing handover with a path update of a target object, according to one or more embodiments;

FIG. 9 is a flow chart illustrating a method performed by a wireless network for sensing handover, according to one or more embodiments;

FIG. 10 is a flow chart illustrating a method for sensing handover between sensing entities, according to one or more embodiments; and

FIG. 11 is a flow chart illustrating a method for sensing handover with an updated sensing path, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

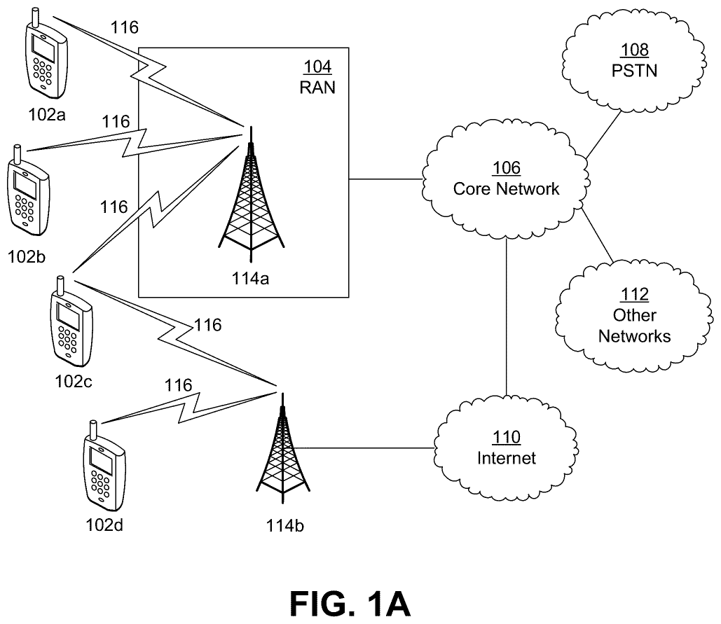

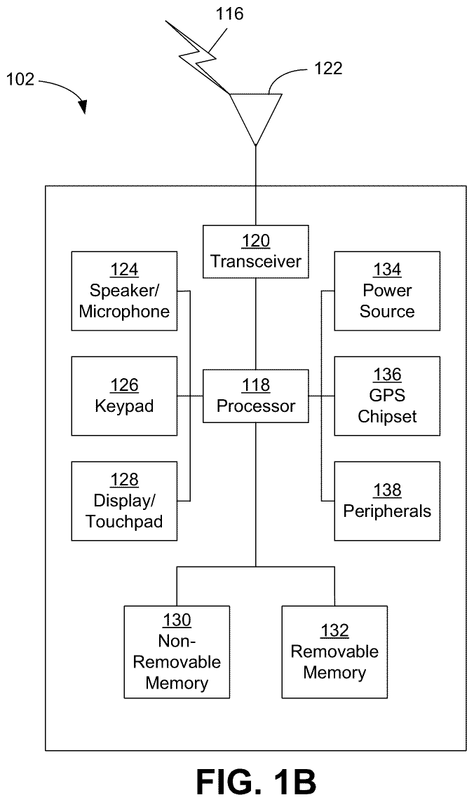

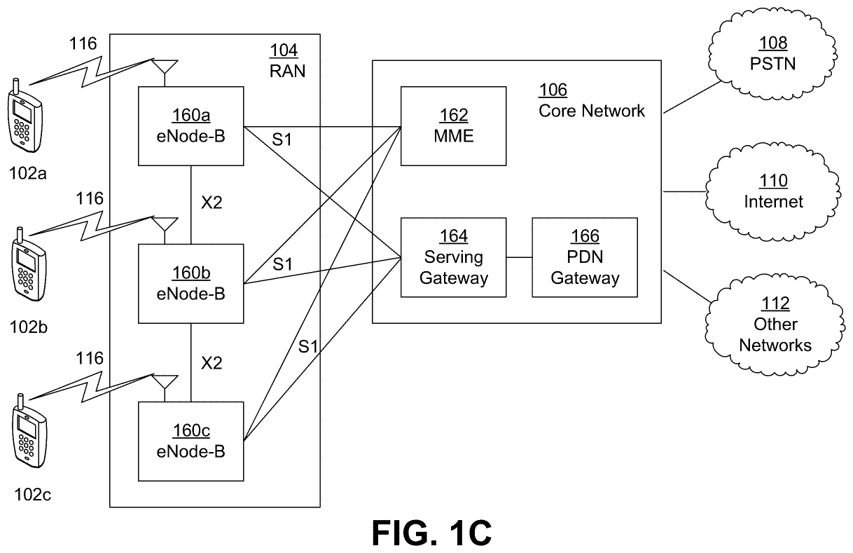

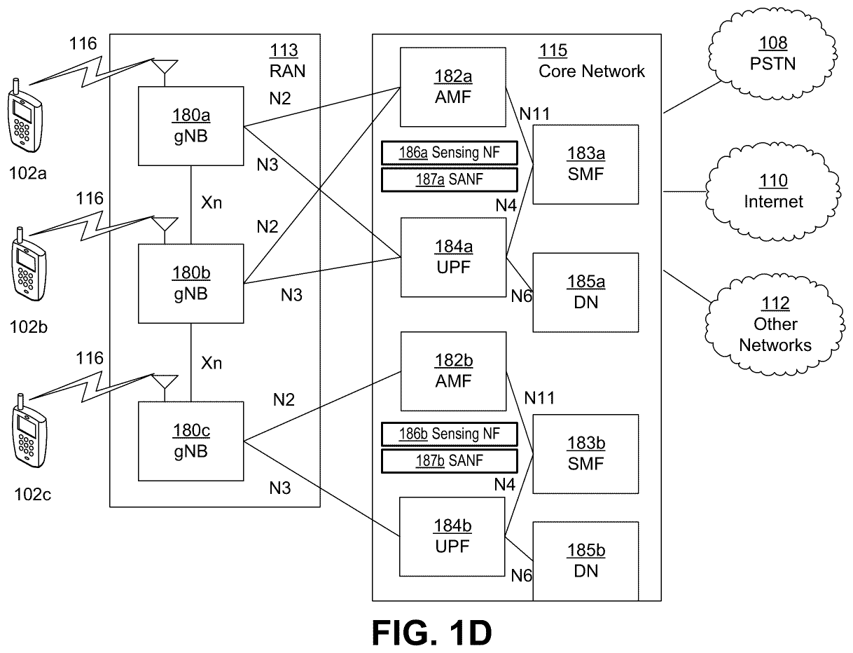

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations (BSs), networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). The frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of the elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of the component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, routing of sensing information towards Sensing Operation Management Function (Sensing NF) 186a, 186b, routing of sensing assistance information towards Sensing Assistance Function (SANF) 187a, 187b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of the elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, Sensing NFs 186a-b, SANFs 187a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Methods, architectures, apparatuses, and systems for mobility support of integrated sensing for tracking are provided. For example, sensing handover, related procedures, and sensing configuration procedures are provided.

In certain representative embodiments, based on path information for a target object, a sensing NF discovers and selects candidate sensing entities for a sensing service area based on path information. For example, when the target object moves across the sensing service area, the sensing NF activates a sensing operation of sensing entities at a next sensing service area.

In certain representative embodiments, sensing handover is controlled by a sensing NF. For example, the sensing NF, after receiving a sensing service request for a tracking service of a target object, discovers and selects sensing entities based on path information. Also, for example, the sensing NF assigns the sensing entities to a group of sensing entities per sensing service area and configures a state of each sensing entity for a sensing operation. Further, for example, the sensing NF configures sensing assistance information to the sensing entities at the group of sensing entities. In addition, for example, the sensing NF determines a sensing result from a received sensing measurement report. Moreover, for example, when detecting movement of the target object to a next sensing service area, the sensing NF activates sensing operations of the group of sensing entities at the next sensing service area. Furthermore, for example, from the sensing NF, the sensing entity (e.g., a WTRU or base station) is assigned to the group of sensing entities and a state for the sensing operation. Additionally, for example, the sensing entity transitions to an active state based on an indication from the sensing NF and performs the sensing operation based on a configuration from the sensing NF.

In certain representative embodiments, a sensing handover between sensing entities is provided. For example, from a sensing NF, a sensing entity (e.g., a WTRU or base station) is assigned to a group of sensing entities and a state for a sensing operation. Also, for example, a (e.g., next) sensing entity is informed of the group of sensing entities at a next sensing service area. Further, for example, the sensing entity transitions to an active state based on an indication from the sensing NF and performs the sensing operation based on a configuration from the sensing NF. In addition, for example, the sensing entity determines a sensing result from a sensing measurement report and detects movement of a target object to the next sensing service area. Moreover, for example, the sensing entity activates the sensing operation at the group of sensing entities at the next sensing service area based on the detected movement of the target object to the next sensing service area.

In certain representative embodiments, sensing handover with an updated sensing path is provided. For example, a sensing NF activates a sensing operation for a tracking service of a target object at a sensing service area based on path information. Also, for example, the sensing NF detects a change of a path of the target object based on a received sensing service request for a path update or a deviation of a detected target object from an original path. Further, for example, the sensing NF discovers and selects sensing entities for a new sensing entities group at a new sensing service area based on updated path information. In addition, for example, the sensing NF updates the sensing entities for tracking of target objects based on updated path information and a discovery result. Moreover, for example, the sensing NF assigns the sensing entities to a group of sensing entities per sensing service area and configures a state of each of the sensing entities for a sensing operation. Furthermore, for example, the sensing NF configures sensing assistance information to the sensing entities at the group of sensing entities. Additionally, for example, when detecting movement of the target object to the next sensing service area, the sensing NF activates the sensing operation of the group of sensing entities at the next sensing service area.

Sensing capabilities and communication systems support network performance, applications, service quality, and other uses. The system architecture for 5G includes network functions, interfaces, and protocols. 5G procedures include mobility management, session management, and policy control.

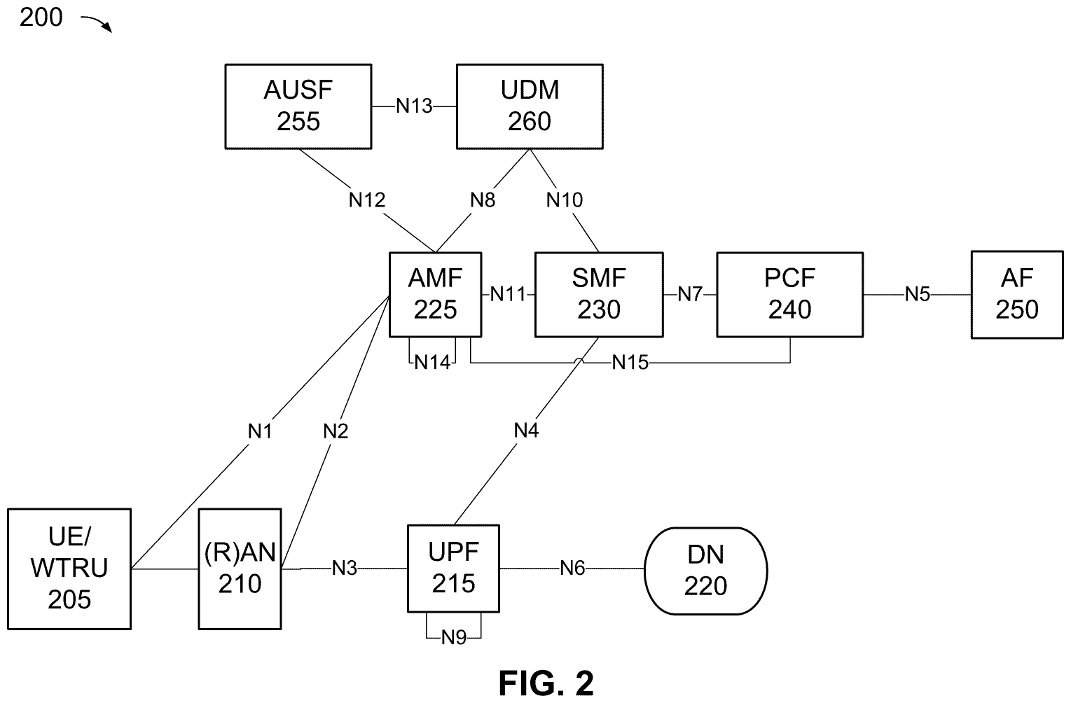

Depicted in FIG. 2 is a reference model 200 of a potential architecture of 5G or NextGen network. For example, the reference model 200 includes at least one of UE (WTRU) 205, (Radio) Access Network ((R)AN) 210, User Plane Function (UPF) 215, Data Network (DN) 220, Access and Mobility Management Function (AMF) 225, Session Management Function (SMF) 230, Policy Control Function (PCF) 240, Application Function (AF) 250, Authentication Server Function (AUSF) 255, Unified Data Management (UDM) 260, combinations of the same, or the like. Also, for example, one or more interfaces Nx therebetween are provided including at least one of: interface N1 between the UE/WTRU 205 and the AMF 225, interface N2 between the (R)AN 210 and the AMF 225, interface N3 between the (R)AN 210 and the UPF 215, interface N4 between the UPF 215 and the SMF 230, interface N5 between the PCF 240 and the AF 250, interface N6 between the UPF 215 and the DN 220, interface N7 between the SMF 230 and the PCF 240, interface N8 between the AMF 225 and the UDM 260, interface N9 between functions of the UPF 215, interface N10 between the SMF 230 and the UDM 260, interface N11 (Namf or Nsmf) between the AMF 225 and the SMF 230, interface N12 between the AMF 225 and the AUSF 255, interface N14 between functions of the AMF 225, interface N15 between the AMF 225 and the PCF 240, combinations of the same, or the like.

The (R)AN 210 refers to a(n) (radio) access network based on a 5G RAT or Evolved E-UTRA that connects to the NextGen core network. The AMF 225 includes at least one of the following functionalities: registration management, connection management, reachability management, mobility management, combinations of the same, or the like. The SMF 230 includes at least one of the following functionalities: session management (e.g., including session establishment, modify and release, or the like), WTRU IP address allocation, selection and control of UP function, combinations of the same, or the like. The UPF 215 includes at least one of the following functionalities: packet routing and forwarding, packet inspection, traffic usage reporting, or the like.

In certain representative embodiments, integrated sensing is provided. For example, integrated sensing for enhancement of a 5G system is provided for sensing services addressing different applications, e.g., autonomous and/or assisted driving, vehicle-to-everything (V2X), unmanned aerial vehicles (UAVs), 3D map reconstruction, smart city, smart home, factories, healthcare, maritime sector, or the like. Also, for example, for integrated sensing, a process of collecting sensing measurement data is provided. Further, for example, the sensing measurement data is data collected about radio and/or wireless signals impacted (e.g., reflected, refracted, diffracted, or the like) by an object or environment of interest for sensing purposes. In addition, for example, the process includes deriving sensing results from processing the sensing measurement data. Moreover, for example, an area is defined for sensing, e.g., a sensing service area (SSA) location. Furthermore, for example, the SSA location is an area location whether with or without obstacle. Additionally, for example, the 5G system provides a sensing service for integrated sensing, e.g., at a certain quality. Still further, for example, other non-3GPP (N3GPP) entities are considered as well and their sensing measurement data is considered as transparent to 5GS such that the data is communicated using a standard protocol to an interface defined by the 5GS.

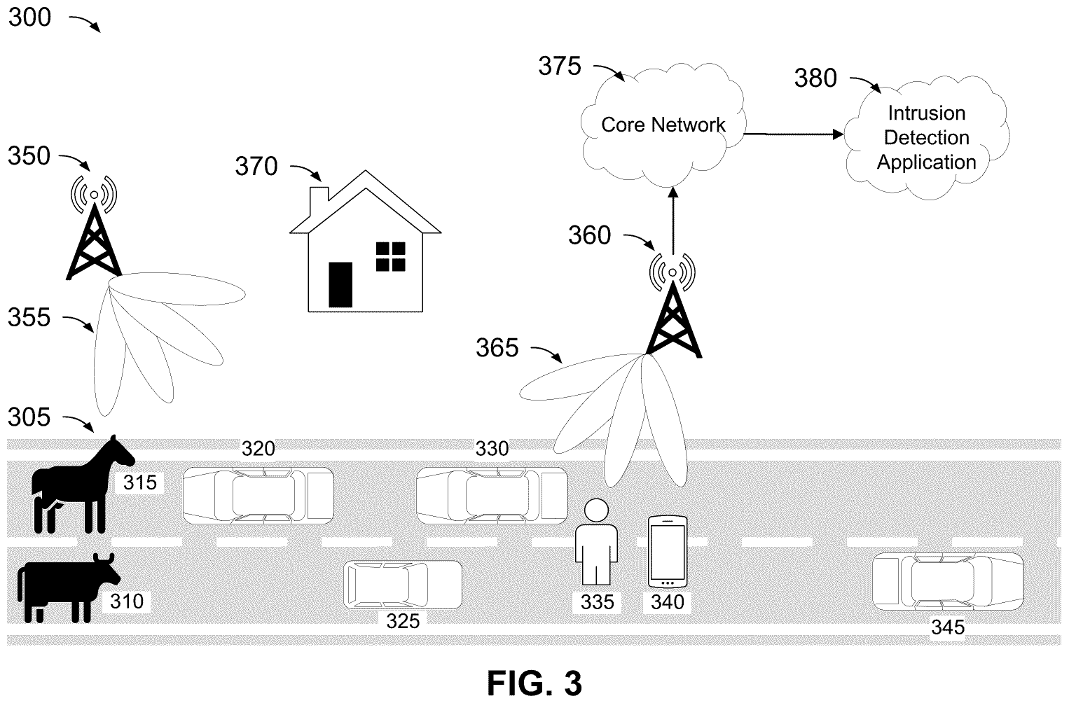

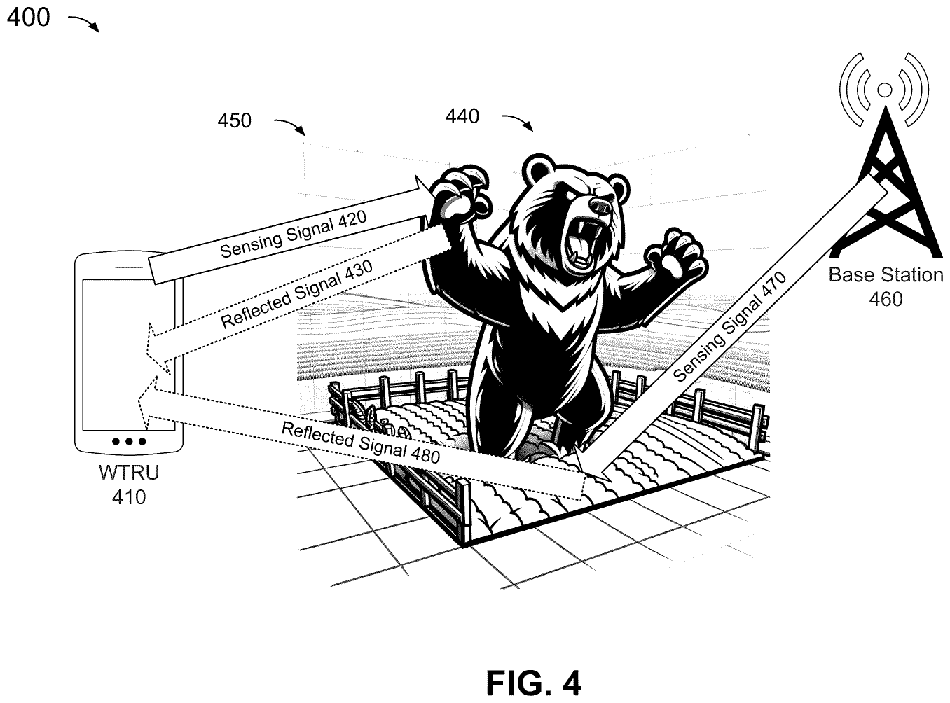

For example, an exemplary use case for integrated sensing is object detection, for example, pedestrian and/or animal intrusion detection on a highway (see, e.g., FIG. 3) or intruder detection in surroundings of smart home (see, e.g., FIG. 4).

As shown in FIG. 3, for example, in an outdoor environment 300, pedestrian and/or animal intrusion detection is provided. The environment 300 includes a highway 305 and a residential property 370 adjacent the highway 305. A base station 350 at a first location and a base station 360 at a second location emit beams 355 and 365, respectively. The beams 355 and 365 interact with the highway 305 and objects 310-345 on the highway 305 such as a first animal (e.g., cow) 310, a second animal (e.g., horse) 315, a first vehicle 320 traveling in a first direction (right-to-left on the page), a second vehicle 325 traveling in a second direction (left-to-right) opposite the first direction, a third vehicle 330 traveling in the first direction, a pedestrian 335 traveling in the first direction, the pedestrian 335 carrying a WTRU 340, and a fourth vehicle 345 traveling in the second direction. Information regarding the highway 305, the property 370, and the objects 310-345 is transmitted by the base stations (the base station 360 in this example) to a core network 375. The core network 375 transmits the information to an intrusion detection application 380. The intrusion detection application 380 is configured to sense, identify, and/or track the objects 310-345, for example, with respect to the base stations 350, 360 and/or one or more fixed points along the highway 305 and/or the property 370. The intrusion detection application 380 may be configured to differentiate between different types of vehicles (e.g., a compact vehicle 325 versus a large vehicle 345) or different types of objects (e.g., a horse 315 versus a human 335) and corresponding locations, directions of movement, velocities, or the like.

As shown in FIG. 4, for example, in an outdoor environment 400, intruder detection in surroundings 450 of a smart home is provided. The environment 400 includes a WTRU 410, an intruder (e.g., a bear) 440, and a base station 460. The WTRU 410 is configured to transmit a sensing signal 420, which, in this example, is incident on the intruder 440. The WTRU 410 is configured to receive a reflected signal 430, which, in this example, reflects the sensing signal 420 after incidence with the intruder 440. The base station 460 is configured to transmit a sensing signal 470, which, in this example, is incident on the surroundings (e.g., the ground) 450. The WTRU 410 is configured to receive a reflected signal 480, which, in this example, reflects the sensing signal 470 after incidence with the surroundings 450.

In the scenarios of FIGS. 3 and 4, a base station (e.g., 350, 360, 460) and/or a WTRU (e.g., 340, 410) can detect the intrusion of an object (e.g., cow 310, vehicle 320, bear 440) into the sensing area of the base station by itself or by collaboration between the WTRU and the base station. For example, the sensing measurement is transferred to the core network 375 and further processed into the sensing result.

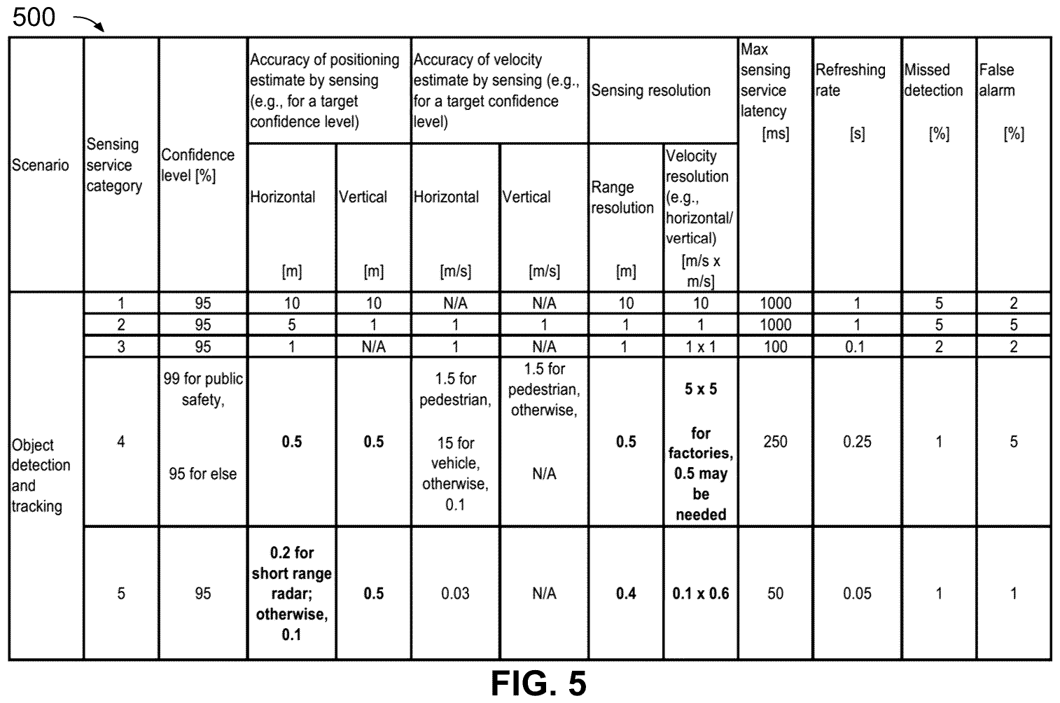

In certain representative embodiments, an integrated sensing service provides object detection and a tracking service. For example, the integrated sensing service is provided with the QoS requirements set forth in FIG. 5.

Table 500 of FIG. 5 outlines key performance indicators (KPIs) for various object detection and tracking scenarios. Table 500 includes details on confidence levels, accuracy of positioning and velocity estimates, sensing resolution, maximum sensing service latency, refreshing rate, missed detection, and false alarm rates. The scenarios vary in terms of the precision required for horizontal and vertical positioning, velocity estimates, and the specific requirements for different applications such as public safety, pedestrian tracking, and short-range radar.

In Scenario 1, the confidence level is 95%. The accuracy of the positioning estimate is 10 meters horizontally and 10 meters vertically. The accuracy of the velocity estimate is not applicable. The sensing resolution includes a range resolution of 10 meters and a velocity resolution of 10 meters per second. The maximum sensing service latency is 1000 milliseconds, with a refreshing rate of 1 second. The missed detection rate is 5%, and the false alarm rate is 2%.

In Scenario 2, the confidence level is 95%. The accuracy of the positioning estimate is 5 meters horizontally and 1 meter vertically. The accuracy of the velocity estimate is 1 meter per second both horizontally and vertically. The sensing resolution includes a range resolution of 1 meter and a velocity resolution of 1 meter per second. The maximum sensing service latency is 1000 milliseconds, with a refreshing rate of 1 second. The missed detection rate is 5%, and the false alarm rate is 5%.

In Scenario 3, the confidence level is 95%. The accuracy of the positioning estimate is 1 meter horizontally and not applicable vertically. The accuracy of the velocity estimate is 1 meter per second horizontally and not applicable vertically. The sensing resolution includes a range resolution of 1 meter and a velocity resolution of 1 meter per second by 1 meter per second. The maximum sensing service latency is 100 milliseconds, with a refreshing rate of 0.1 second. The missed detection rate is 2%, and the false alarm rate is 2%.

In Scenario 4, the confidence level is 99% for public safety and 95% for others. The accuracy of the positioning estimate is 0.5 meters both horizontally and vertically. The accuracy of the velocity estimate is 1.5 meters per second for pedestrians, 15 meters per second for vehicles, and 0.1 meters per second otherwise horizontally, and 1.5 meters per second for pedestrians and not applicable otherwise vertically. The sensing resolution includes a range resolution of 0.5 meters and a velocity resolution of 5 meters per second by 5 meters per second, with 0.5 meters per second for some factories. The maximum sensing service latency is 250 milliseconds, with a refreshing rate of 0.25 second. The missed detection rate is 1%, and the false alarm rate is 5%.

In Scenario 5, the confidence level is 95%. The accuracy of the positioning estimate is 0.02 meters for short-range radar and 0.1 meters otherwise horizontally, and 0.5 meters vertically. The accuracy of the velocity estimate is 0.03 meters per second horizontally and not applicable vertically. The sensing resolution includes a range resolution of 0.4 meters and a velocity resolution of 0.1 meters per second by 0.6 meters per second. The maximum sensing service latency is 50 milliseconds, with a refreshing rate of 0.05 second. The missed detection rate is 1%, and the false alarm rate is 1%.

In certain representative embodiments, an integrated sensing operation is enabled for tracking a target WTRU with mobility. There are several use cases with a UAV for integrated sensing such as intrusion detection, tracking, collision avoidance, or the like. For example, a sensing service is provided with a high granularity of less than 1 meter. For example, detection and tracking of the UAV may require a sensing service with accuracy of 0.5×0.5 square meter and resolution of 0.5 m. In order to provide a tracking service for the UAV at this level of requirement, a sensing operation across a sensing service area is continued in a seamless manner while the UAV moves from one sensing service area to another sensing service area.

As a sensing operation may involve multiple BSs and WTRUs, for efficient sensing operation, a sensing operation may start when the UAV enters a sensing service area and may stop when the UAV moves out of the sensing service area.

Discovery of sensing entities and coordination of sensing operations among various sensing entities is provided so that imminent sensing operation is possible on arrival of an object (e.g., the UAV) at the target sensing service area.

In certain representative embodiments, tracking of sensing operation is provided. For example, when a target WTRU (e.g., a UAV) moves from a cell (e.g., a sensing service area) to a next cell, a sensing operation is prepared at the next cell for continued sensing operation. Also, for example, when multiple BSs and WTRUs across multiple sensing service areas are involved for supporting mobility of target WTRU, integrated sensing operations are performed ensuring energy and resource efficiency. Further, for example, the examples described above are applicable to UAV tracking and may be extended to other use cases, e.g., vehicle navigation.

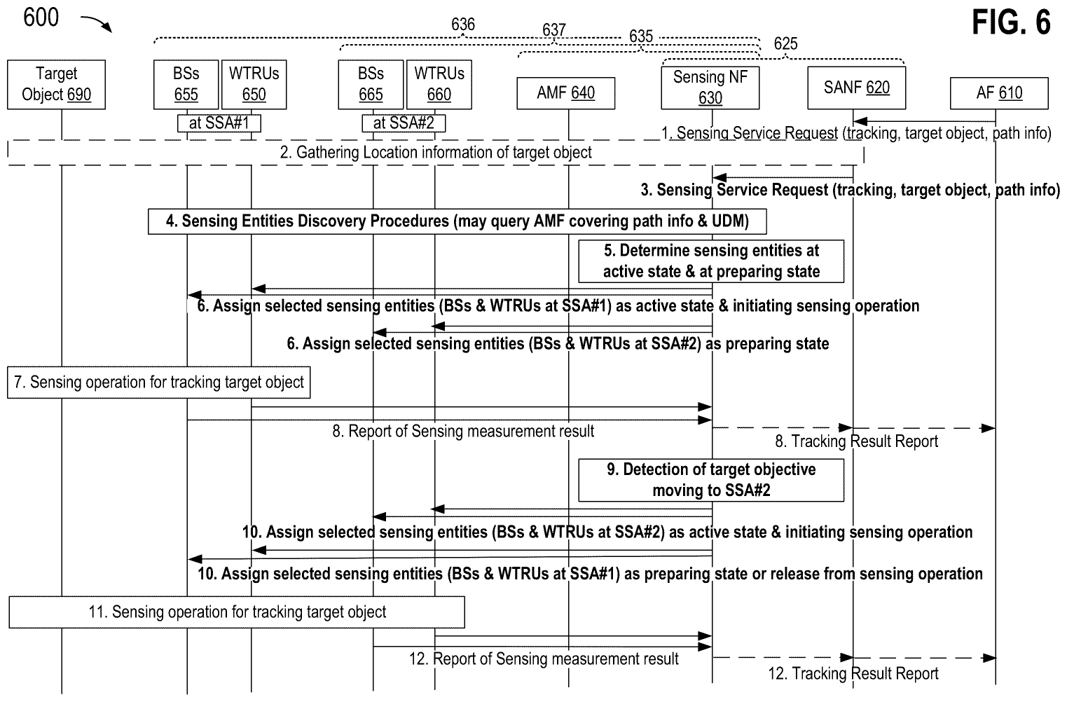

For example, for handling a sensing service, one or more network functions are provided. Also, for example, a network function includes a Sensing Assistance Function (SANF) 187a, 187b and/or a Sensing Operation Management Function (Sensing NF) 186a, 186b (see, also, FIGS. 6-8). Further, for example, the SANF 187a, 187b and/or the Sensing NF 186a, 186b are logical entities. In addition, for example, the SANF 187a, 187b and/or the Sensing NF 186a, 186b may be collocated with one or more other network entities. Moreover, for example, the SANF 187a, 187b and/or the Sensing NF 186a, 186b are collocated with a Network Exposure Function (NEF). Furthermore, for example, the SANF 187a, 187b and the Sensing NF 186a, 186b are implemented at a same network entity. Additionally, for example, for example, the Sensing NF 186a, 186b is implemented by the AMF (e.g., 182a, 182b; see, also, FIGS. 6-8). Still further, for example, the Sensing NF 186a, 186b is implemented by a sensing entity (e.g., WTRU 102 and/or base station 114a, 114b; see, also, FIGS. 6-8).

In some embodiments, SANF 620, 720, or 820 and Sensing NF 630, 730, or 830, respectively, are a same function, denoted with a bracket 625, 725, or 825, respectively. In these embodiments, the steps between SANF and Sensing NF are performed by the combined function 625, 725, or 825, respectively, and information (e.g., according to the steps below) is transmitted and/or received by the combined function 625, 725, or 825, respectively.

In some embodiments, Sensing NF 630, 730, or 830 and AMF 640, 740, or 840, respectively, are a same function, denoted with a bracket 635, 735, or 835, respectively. In these embodiments, the steps between Sensing NF and AMF are performed by the combined function 635, 735, or 835, respectively, and information (e.g., according to the steps below) is transmitted and/or received by the combined function 635, 735, or 835, respectively.

In some embodiments, Sensing NF 630, 730, or 830 and one or more sensing units (e.g., one or more of WTRUs 650, 750, or 850, and one or more of BSs 655, 755, or 855, respectively) are a same functional entity, denoted with a bracket 636, 736, or 836, respectively. In these embodiments, the steps between Sensing NF and the one or more sensing units are performed by the combined functional entity 636, 736, or 836, respectively, and information (e.g., according to the steps below) is transmitted and/or received by the combined functional entity 636, 736, or 836, respectively.

In some embodiments, Sensing NF 630, 730, or 830 and one or more sensing units (e.g., one or more of WTRUs 660, 760, or 860, and one or more of BSs 665, 765, or 865, respectively) are a same functional entity, denoted with a bracket 637, 737, or 837, respectively. In these embodiments, the steps between Sensing NF and the one or more sensing units are performed by the combined functional entity 637, 737, or 837, respectively, and information (e.g., according to the steps below) is transmitted and/or received by the combined functional entity 637, 737, or 837, respectively.

In some embodiments, Sensing NF 830 and one or more sensing units (e.g., one or more of WTRUs 870, and one or more of BSs 875) are a same functional entity, denoted with a bracket 838. In these embodiments, the steps between Sensing NF and the one or more sensing units are performed by the combined functional entity 838, and information (e.g., according to the steps below) is transmitted and/or received by the combined functional entity 838.

For example, the SANF 187a, 187b interacts with an Application Function (AF) (e.g., 250; see, also, FIGS. 6-8) for sensing services. Still further, for example, the SANF 187a, 187b receives a service request from the AF and derives a corresponding requested sensing mechanism. Even further, for example, after determining the requested sensing mechanism, the SANF 187a, 187b sends a request to sensing NF 186a, 186b (e.g., directly or via AMF (e.g., 182a, 182b; see, also, FIGS. 6-8), or the like for sensing operation. Later, SANF 187a, 187b receives the report from Sensing NF 186a, 186b (e.g., directly or via AMF (e.g., 182a, 182b; see, also, FIGS. 6-8), or the like), and SANF 187a, 187b reports the result to the AF.

When AF is third party application which is not a trusted entity of 5GS, AF and SANF may communicate through NEF with the AF. An AF may push the updated requirements or configurations, such as QoS, via NEF to the sensing NFs.

In certain representative embodiments, at least one of the following is provided: sensing handover managed by sensing NF, sensing handover between sensing entities, support of sensing handover with path update, combinations of the same, or the like.

In certain representative embodiments, regarding sensing handover managed by sensing NF, after discovery and selection of sensing entities by sensing NF, the selected sensing entities may be assigned a state of sensing operation such as active, prepared and released. For example, the state includes at least one of an active state, a prepared state, a release state, or the like. Also, for example, the active state is the state when the sensing entities are in operation of sensing (e.g., sending sensing signal, receiving sensing signal, measuring sensing signal, reporting the measured result, or the like). Further, for example, the prepared state is the state when the sensing entities are notified to be involved for sensing operation and configured with sensing assistance information for sensing but not yet in active state (e.g., sensing assistance information may include sensing mechanism, wave form of sensing signal, resource pool, period of sensing measurement, or the like). In addition, for example, the release state is the state when the sensing entities are not involved in sensing operation and not configured for sensing operation. Moreover, for example, a state transition among active, prepared, and release is based on an indication or a configuration from sensing NF. Furthermore, for example, there may be explicit indication to enter an active state or a release state. Additionally, for example, the prepared state corresponds to a state when sensing entities are configured with assistance information.

In certain representative embodiments, as shown in FIG. 6, a process 600 for sensing handover based on path information of target object is provided. For example, the process 600 includes steps between at least one of AF 610, SANF 620, Sensing NF 630, AMF 640, one or more (first) WTRUs 650 at a first SSA #1, one or more (first) BSs 655 at the first SSA #1, one or more (second) WTRUs 660 at a second SSA #2, one or more (second) BSs 665 at the second SSA #2, a target object 690, or the like. Also, for example, as noted above, one or more of the steps performed by the Sensing NF 630 may be performed by and/or integrated with at least one of the SANF 620, the AMF 640, one or more sensing entities (e.g., WTRUs or BSs), or the like. Further, for example, the process 600 includes at least one of the steps 1-12 described below in any suitable order.
Step 1. For example, AF 610 may send a sensing service request for tracking of target object 690 to SANF 620. Also, the sensing service request may include information of target object 690, requested sensing service type with requested QoS level (e.g., granularity, accuracy, conformance rate, or the like) as tracking, and expected path information of the target object 690 (e.g., list of geographic points).
Step 2. For example, SANF 620 may gather location information of target object 690 (e.g., request location service to network for the target object 690) to identify the proper Sensing NF 630 (e.g., to identify one or more sensing entities which manage the sensing operation of the service area including location of target object 690).

Also, for example, SANF 620 may translate the expected path information of the target object 690 to the sensing service area information (e.g., tracking area, sensing service area, or the like) understandable in the network and include that information in the sensing service request to the Sensing NF 630 as the path information.

As another embodiment, SANF 620 may request an analytic service on mobility of a target WTRU to NW Data Analytics Function (NWDAF) (e.g., when AF 610 requests tracking sensing service of target object but path information is not provided in step 1). For example, based on information from NWDAF on mobility of target WTRU analysis, an expected path of target WTRU may be decided and may be included in sensing service request Sensing NF 630 at step 3.
Step 3. For example, SANF 620 may send sensing service request to Sensing NF 630 for tracking of target object 690. Also, for example, the sensing service request may include information of target object 690 and path information.
Step 4. For example, Sensing NF 630 may perform discovery procedures to discover sensing entities for tracking service using the path information received in step 3. Also, for example, in order to select proper sensing entities (e.g., WTRUs and Base Stations, or the like) for tracking object along the path, Sensing NF 630 may communicate with one or more AMFs 640 covering area corresponding to the path information and UDM, to query list of sensing entities.

For example, based on path information, the sensing service area may be identified as ordered list [SSA_1, SSA_2, SSA_3, SSA_4], which means target object 690 moves from SSA_1 to SSA_4 through SSA_2 and SSA_3. Also, for example, Sensing NF 630 discovers sensing entities for tracking of object at SSA_1, SSA_2, SSA_3, and SSA_4. Further, for example, as a result of discovery, for each sensing service area, sensing service entities (e.g., BSs and WTRUs, or the like) may be discovered and selected.

In addition, for example, the discovered and selected group of sensing entities at sensing service area may be noted as SE_SSA. For example, for SSA_1, the selected group of sensing entities (e.g., or group of sensing entities) is noted as SE_SSA_1.
Step 5. For example, based on position and path information of target object 690, Sensing NF 630 may decide a sensing operation state of a sensing entities group as active or prepared. Also, for example, based on current position and/or path information of target object 690, SE_SSA_1 may be determined as active and SE_SSA_2, SE_SSA_3, and SE_SSA_4 are determined as prepared.
Step 6. For example, Sensing NF 630 sends an assigned group of sensing entities information (e.g., SE_SSA_1, SE_SSA_2, or the like) and sensing assistance information to each member of the selected group of sensing entities. Also, for example, for each group of sensing entities, different sensing assistance information will be configured. Further, for example, if the sensing entity is a WTRU, Sensing NF 630 may send assignment and assistance information as a NAS message (e.g., via AMF 640 which serves the sensing entity; e.g., WTRU configuration update). In addition, for example, if the sensing entity is a Base Station, Sensing NF 630 may send assignment and assistance information via an N2 procedure and/or message (e.g., via AMF 640).

Moreover, for example, sensing assistance information includes a determination of whether sensing measurement report will be transferred via control plane (CP) or via user plane (UP). Furthermore, for example, sensing assistance information also includes time information for transmitting sensing measurement report (e.g., interval between one sensing measurement report and the next sensing measurement report, or the like).

Additionally, for example, when sensing assistance information indicates a sensing measurement report over the UP, the sensing assistance information includes the information for a PDU session setup (e.g., data network name (DNN), session and service continuity (SSC) mode, or the like) and a server address to access for sending sensing data. Still further, for example, a sensing entity (e.g., WTRU) may setup the PDU session for a sensing measurement report when the sensing entity receives sensing assistance information indicating sensing measurement report over the UP.

Even further, for example, Sensing NF 630 may inform each sensing entity of the information of other member entities belonging to the same group of sensing entities.

Yet further, for example, Sensing NF 630 also assigns selected group of sensing entities the state of sensing operation as determined at step 5.

For example, SE_SSA_1 may be assigned as active state, and SE_SSA_2, SE_SSA_3, and SE_SSA_4 may be assigned as prepared state.

It is noted that step 6 may involve, for example, at least one of one or more sensing entities, one or more of WTRUs 650, one or more of BSs 655, one or more of WTRUs 660, one or more of BSs 665, combinations of the same, or the like.
Step 7. For example, the group of sensing entities (e.g., one or more of WTRUs 650, one or more of BSs 655, or the like) assigned as active state start sensing operation as configured by Sensing NF 630.

One or more other groups of sensing entities assigned as prepared state (e.g., SE_SSA_2, SE_SSA_3, SE_SSA_4, or the like) wait for indication from Sensing NF 630 for state change.
Step 8. For example, the group of sensing entities at active state reports the sensing measurement result to Sensing NF 630.

Also, for example, Sensing NF 630 may calculate the sensing result from sensing measurement result for tracking of target object 690 (e.g., determine whether the target object 690 keep the path as path information, determine the location of target object 690, or the like) and report the sensing result to SANF 620. Further, for example, SANF 620 may report the result to AF 610.

As another embodiment, a sensing result may be calculated by some sensing entity. In this case, in step 8, sensing result is reported to Sensing NF 630.

As another embodiment, a sensing result may be calculated by SANF 620 or AF 610. In this case, in step 8, Sensing NF 630 reports the sensing measurement result to SANF 620.

Additionally, Sensing NF 630 may evaluate whether the object, which is detected and monitored by sensing operation, is the target object 690 at the sensing request. For example, Sensing NF 630 may get informed from RAN node (e.g., gNB, BS, or the like). Also, for example, the Sensing NF 630 may be informed from the RAN node when at least one of the following occurs: when RAN node may communicate with sensed object, when RAN node may monitor any signal broadcasted from the object via Uu channel or PC5 channel (e.g., the object may regularly broadcast its identity), when non-3GPP based method is available for communicating with the sensed object, combinations of the same, or the like.
Step 9. For example, Sensing NF 630 may detect the target object 690 is moving to SSA_2 based on a sensing result report from sensing entities, a sensing result report calculated by Sensing NF 630, or an indication from SANF 620 (e.g., or AF 610).

As another embodiment, Sensing NF 630 may detect the target object 690 is moving to another SSA by notification from other network function (e.g., AMF 640, LMF, or the like) or RAN entities.
Step 10. For example, after detecting the target object 690 is moving to SSA_2, Sensing NF 630 sends an indication to SE_SSA_2 to transition to active state. Also, for example, Sensing NF 630 may send an indication to SE_SSA_1 to transition to prepared state or release state.

As another embodiment, Sensing NF 630 may send an indication to SE_SSA_2, which is next to SE_SSA_1 based on path information, to transition to active state, when Sensing NF 630 detects sensing object enters or locates at SE_SSA_1. Similarly, for example, when Sensing NF 630 detects target object 690 is located at SE_SSA_2, it may inform SE_SSA at next SSA based on path information (e.g., SE_SSA_3).

It is noted that step 10 may involve, for example, at least one of one or more sensing entities, one or more of WTRUs 650, one or more of BSs 655, one or more of WTRUs 660, one or more of BSs 665, combinations of the same, or the like.
Step 11. For example, based on the indication, SE_SSA_2 transitions to active state and starts a sensing operation for tracking target object 690.
Step 12. For example, a group of sensing entities at active state reports the sensing measurement result to Sensing NF 630.

Also, for example, Sensing NF 630 may calculate the sensing result from sensing measurement result for tracking of target object 690 (e.g., determine whether the target object 690 keep the path as path information, determine the location of target object 690, or the like) and report the sensing result to SANF 620. Further, for example, SANF 620 may report the result to AF 610.

As another embodiment, sensing result may be calculated by some sensing entity. In this case, in step 12, sensing result is reported to Sensing NF 630.

As another embodiment, sensing result may be calculated by SANF 620 or AF 610. In this case, in step 12, Sensing NF 630 report the sensing measurement result to SANF 620.

Based on movement of target object 690, whenever Sensing NF 630 detects target object 690 move to new SSA along the path information, Sensing NF 630 repeats step 8 to step 12 with corresponding one or more SE_SSAs.

In certain representative embodiments, regarding sensing handover between sensing entities, for some sensing operations, a sensing result calculation may be possible at sensing entities (e.g., BS or WTRU, or the like). For example, when one or more sensing entities are able to calculate a sensing result for some sensing service, the one or more sensing entities may report its capability of a sensing result calculation to a network. Also, for example, the network may refer this capability for discovery and selection of sensing entities. For another embodiment, the sensing result calculation capability may be different per sensing service. Further, for example, supported sensing services may be reported together with sensing capability for calculation to the network.

In addition, for example, when sensing entities (e.g., BSs and WTRUs, or the like) can calculate sensing result, sensing handover may be handled between sensing entities at adjacent sensing service area.

Moreover, for example, when sensing entities detects movement of target object to next sensing service area, sensing handover may be indicated to the sensing entities at next sensing service area.

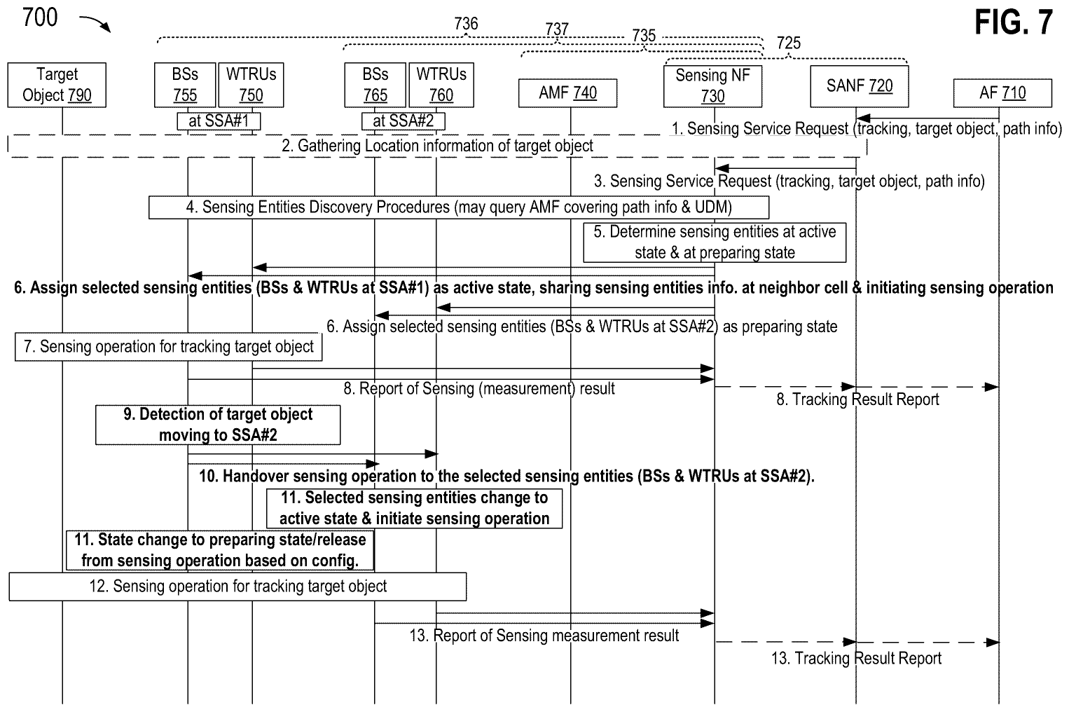

In certain representative embodiments, as shown in FIG. 7, a process 700 for sensing handover based on path information of target object is provided. For example, the process 700 includes steps between at least one of AF 710, SANF 720, Sensing NF 730, AMF 740, one or more (first) WTRUs 750 at a first SSA #1, one or more (first) BSs 755 at the first SSA #1, one or more (second) WTRUs 760 at a second SSA #2, one or more (second) BSs 765 at the second SSA #2, a target object 790, or the like. Also, for example, as noted above, one or more of the steps performed by the Sensing NF 730 may be performed by and/or integrated with at least one of the SANF 720, the AMF 740, one or more sensing entities (e.g., WTRUs or BSs), or the like. Further, for example, the process 700 includes at least one of the steps 1-13 described below in any suitable order.
Step 1. For example, AF 710 may send a sensing service request for tracking of target object 790 to SANF 720. Also, for example, the sensing service request may include information of target object 790, requested sensing service type with requested QoS level (e.g., granularity, accuracy, conformance rate, or the like) as tracking, and expected path information of the target object 790 (e.g., list of geographic points).
Step 2. For example, SANF 720 may gather location information of target object 790 (e.g., request location service to network for the target object 790) to identify the proper Sensing NF 730 (e.g., to identify sensing entity which manage the sensing operation of the service area including location of target object 790).

Also, for example, SANF 720 may translate the expected path information of the target object 790 to service area information (e.g., tracking area, sensing service area, or the like) understandable in the network and include that information in the sensing service request to the Sensing NF 730 as path information.
Step 3. For example, SANF 720 may send sensing service request to Sensing NF 730 for tracking of target object 790. Also, for example, the sensing service request may include information of target object 790 and path information.
Step 4. For example, Sensing NF 730 may perform discovery procedures to discover sensing entities for tracking service using the path information received in step 3. Also, for example, to select proper sensing entities (e.g., WTRUs and base stations, or the like) for tracking object along the path, Sensing NF 730 may communicate with one or more AMF 740s covering area corresponding to the path information and UDM, to query list of sensing entities.

For example, based on path information, the sensing service area may be identified as ordered list [SSA_1, SSA_2, SSA_3, SSA_4], which means target object 790 moves from SSA_1 to SSA_4 through SSA_2 and SSA_3. Also, for example, Sensing NF 730 discover sensing entities for tracking of object at SSA_1, SSA_2, SSA_3, and SSA_4. Further, for example, as a result of discovery, for each sensing service area, sensing service entities (e.g., BSs and WTRUs, or the like) may be discovered and selected.

In addition, for example, based on information of discovered sensing entities, when sensing entities can calculate the sensing results at a sensing service area, Sensing NF 730 may decide to utilize sensing calculations by sensing entities (e.g., sensing entity based sensing result calculation). For example, in FIG. 7, SE_SSA_1 is determined to utilize sensing entity based sensing result calculations.

Moreover, for example, the discovered and selected group of sensing entities at sensing service area may be noted as SE_SSA. For example, for SSA_1, the selected group of sensing entities (e.g., or group of sensing entities) is noted as SE_SSA_1.
Step 5. For example, based on position and path information of target object 790, Sensing NF 730 may decide sensing operation state of group of sensing entities as active or prepared. Also, for example, based on current position and/or path information of target object 790, SE_SSA_1 may be determined as active and SE_SSA_2, SE_SSA_3, and SE_SSA_4 are determined as prepared.
Step 6. For example, Sensing NF 730 send assigned group of sensing entities information (e.g., SE_SSA_1, SE_SSA_2, or the like) and sensing assistance information to each member of the selected group of sensing entities. Also, for example, for each group of sensing entities, different sensing assistance information will be configured.

Further, for example, if the sensing entity is a WTRU, Sensing NF 730 may send assignment and assistance information as a NAS message (e.g., via AMF 740 which serves the sensing entity; e.g., WTRU configuration update). In addition, for example, if the sensing entity is a Base Station, Sensing NF 730 may send assignment and assistance information via an N2 procedure and/or message (e.g., via AMF 740).

Moreover, for example, sensing assistance information includes whether sensing measurement report will be transferred via Control plane (CP) or via user plane (UP). Furthermore, for example, sensing assistance information also includes time information for transmitting sensing measurement report (e.g., interval between one sensing measurement report and the next sensing measurement report, or the like).

Additionally, for example, when sensing assistance information indicate sensing measurement report over user plane, sensing assistance information include the information for PDU session setup (e.g., DNN, SSC mode, or the like) and server address to access for sending sensing data. Still further, for example, sensing entity (e.g., WTRU) may setup PDU session for sensing measurement report when it receives sensing assistance information indicating sensing measurement report over User Plane. Even further, for example, Sensing NF 730 may inform each sensing entity of the information of other member entities belonging to the same group of sensing entities.

Yet further, for example, sensing NF 730 also assigns selected group of sensing entities the state of sensing operation as determined at step 5. For example, SE_SSA_1 may be assigned as active state and SE_SSA_2, SE_SSA_3, and SE_SSA_4 are assigned as prepared state.

Further still, for example, for one or more SE_SSAs, Sensing NF 730 may decide to utilize sensing entity-based sensing result calculation and indicate this to the relevant SE_SSA. For example, when sensing entity-based sensing result calculation is indicated, Sensing NF 730 may inform the information of sensing entities at the next sensing service area so that sensing entity detects movement of target object 790 to next SSA, and the Sensing NF 730 may inform to sensing entities at corresponding SE_SSA. Also, for example, SE_SSA_1 is informed sensing entity-based sensing result calculation and may be shared with information of SE_SSA_2.

Further, for example, sensing assistance information may include indication whether sensing entity-based sensing result calculation is utilized or not. In addition, for example, if sensing entity-based sensing result calculation is enabled, it will also include how the sensing result may be transmitted to Sensing NF 730 (e.g., via UP or CP and relevant information for UP setup, if UP is used, or the like).

It is noted that step 6 may involve, for example, at least one of one or more sensing entities, one or more of WTRUs 750, one or more of BSs 755, one or more of WTRUs 760, one or more of BSs 765, combinations of the same, or the like.

Step 7. For example, the group of sensing entities assigned as active state start sensing operation as configured by Sensing NF 730.

Also, for example, at least one sensing entity of another group of sensing entities assigned as prepared state (e.g., SE_SSA_2, SE_SSA_3, SE_SSA_4, or the like) waits for indication from Sensing NF 730 for state change.

Step 8. For example, a group of sensing entities at active state reports the sensing measurement result to Sensing NF 730.

Also, for example, when for some SE_SSA (e.g., here, SE_SSA1), sensing entity based calculation is utilized, group of sensing entities may report sensing result to Sensing NF 730.

Further, for example, Sensing NF 730 may calculate the sensing result from sensing measurement result for tracking of target object 790 (e.g., determine whether the target object 790 keep the path as path information, determine the location of target object 790, or the like) and report the sensing result to SANF 720. In addition, for example, SANF 720 may report the result to AF 710.

Step 9. For example, for some SSA, sensing entities may calculate sensing result and may detect the target object 790 is moving to next sensing service area (e.g., sensing entities at SE_SSA_1 may detect target object 790 moves to SSA_2).

Step 10. For example, after detecting the target object 790 is moving to next SSA (e.g., SSA_2), sensing entities send an indication of sensing handover to SE_SSA_2 to transition to active state.

Step 11. For example, based on the indication, SE_SSA_2 transitions to active state and starts sensing operation for tracking target object 790.

Also, for example, after sensing handover, SE_SSA at old SSA (e.g., SE_SSA_1) may transition to prepared state or release state by its own discretion.

It is noted that step 11 may involve, for example, at least one of one or more sensing entities, one or more of WTRUs 750, one or more of BSs 755, one or more of WTRUs 760, one or more of BSs 765, combinations of the same, or the like.

Steps 12-13. For example, at least one sensing entity of a group of sensing entities at active state reports the sensing measurement result to Sensing NF 730.

It is noted that step 12 may involve, for example, at least one of one or more sensing entities, one or more of WTRUs 750, one or more of BSs 755, one or more of WTRUs 760, one or more of BSs 765, combinations of the same, or the like.

Also, for example, Sensing NF 730 may calculate the sensing result from sensing measurement result for tracking of target object 790 (e.g., determine whether the target object 790 keep the path as path information, determine the location of target object 790, or the like) and report the sensing result to SANF 720. Further, for example, SANF 720 may report the result to AF 710. As another embodiment, sensing result may be calculated by some sensing entity. In this case, in step 12, sensing result is reported to Sensing NF 730.

In addition, for example, based on movement of target object 790, whenever Sensing NF 730 detects target object 790 move to new SSA along the path information, Sensing NF 730 repeats steps 8 to step 12 with one or more corresponding SE_SSAs.

In certain representative embodiments, support of sensing handover with path update is provided. For example, a UAV may have to deviate from an initial plan. Also, for example, deviation may be in response to weather conditions (e.g., high wind conditions), traffic, resource limitations of the UAV (e.g., battery) or the sensing and/or communication (e.g., next BS is congested).

Further, for example, in an abnormal case (such as those noted above), Application Function (UAS Service Supplier) (AF(USS)) may determine the situation and update to a new path or Sensing NF may respond to potential deviation for maintaining UAV tracking.

In addition, for example, for these abnormal cases, sensing entities for sensing handover are updated for the new path. Moreover, for example, when new path update is triggered by AF, Sensing NF may configure new sensing entities before sensing handover based on the new path. Furthermore, for example, when deviation of target object from path info is detected by Sensing NF, Sensing NF may configure new sensing entities at the neighbor sensing service area of original path information. Additionally, for example, when detecting to enter new area, the new area is informed to activate sensing.

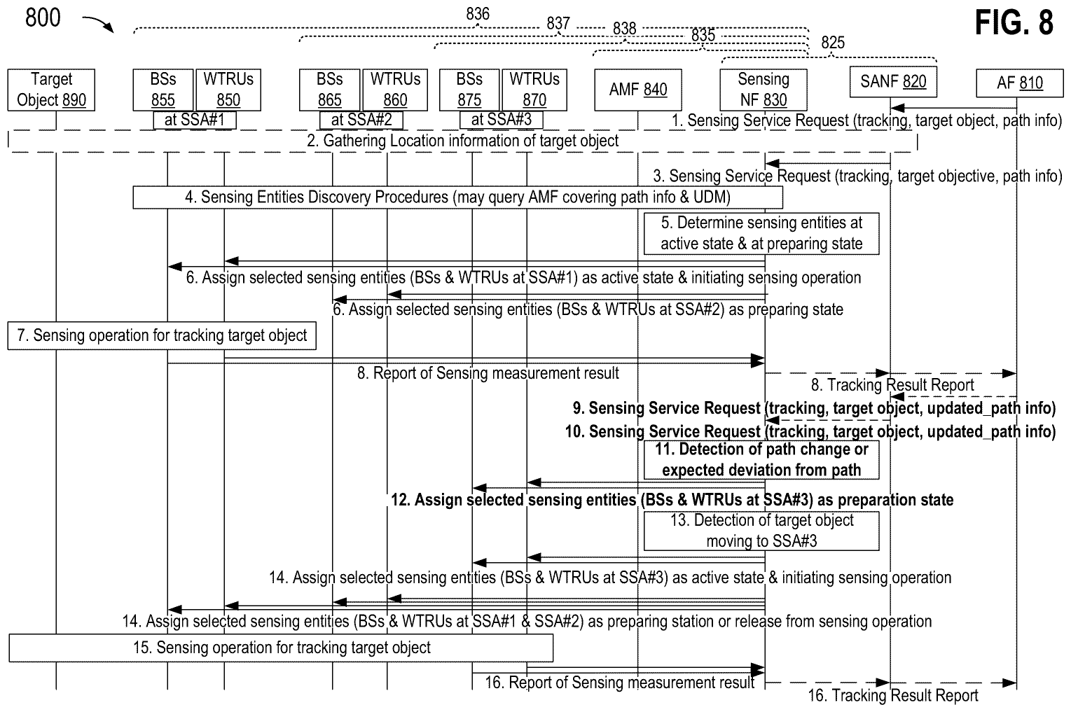

FIG. 8: sensing handover with path update of target object.

In certain representative embodiments, as shown in FIG. 8, a process 800 for sensing handover based on path information of target object is provided. For example, the process 800 includes steps between at least one of AF 810, SANF 820, Sensing NF 830, AMF 840, one or more (first) WTRUs 850 at a first SSA #1, one or more (first) BSs 855 at the first SSA #1, one or more (second) WTRUs 860 at a second SSA #2, one or more (second) BSs 865 at the second SSA #2, one or more (third) WTRUs 870 at a third SSA #3, one or more (third) BSs 875 at the third SSA #3, a target object 890, or the like. Also, for example, as noted above, one or more of the steps performed by the Sensing NF 830 may be performed by and/or integrated with at least one of the SANF 820, the AMF 840, one or more sensing entities (e.g., WTRUs or BSs), or the like. Further, for example, the process 800 includes at least one of the steps 1-16 described below in any suitable order.
Step 1. For example, AF 810 may send a sensing service request for tracking of target object 890 to SANF 820. Also, for example, the sensing service request may include information of target object 890, requested sensing service type with requested QoS level (e.g., granularity, accuracy, conformance rate, or the like) as tracking, and expected path information of the target object 890 (e.g., list of geographic points).
Step 2. For example, SANF 820 may gather location information of target object 890 (e.g., request location service to network for the target object 890) to identify the proper Sensing NF 830 (e.g., to identify sensing entity which manage the sensing operation of the sensing service area including location of target object 890).

Also, for example, SANF 820 may translate the expected path information of the target object 890 to service area information (e.g., tracking area, sensing service area, or the like) understandable in the network and include that information in the sensing service request to the Sensing NF 830 as path information.
Step 3. For example, SANF 820 may send sensing service request to Sensing NF 830 for tracking of target object 890. Also, for example, the sensing service request may include information of target object 890 and path information.
Step 4. For example, Sensing NF 830 may perform discovery procedures to discover sensing entities for tracking service using the path information received in step 3. Also, for example, in order to select proper sensing entities (e.g., WTRUs and base stations, or the like) for tracking object along the path, Sensing NF 830 may communicate with one or more AMF 840s 640 covering area corresponding to the path information and UDM, to query list of sensing entities.

For example, based on path information, the sensing service area may be identified as ordered list [SSA_1, SSA_2, SSA_4], which means target object 890 moves from SSA_1 to SSA_4 through SSA_2. Also, for example, Sensing NF 830 discover sensing entities for tracking of object at SSA_1, SSA_2, and SSA_4. Further, for example, as a result of discovery, for each sensing service area, sensing service entities (e.g., BSs and WTRUs, or the like) may be discovered and selected.

For example, the discovered and selected group of sensing entities at sensing service area may be noted as SE_SSA. Also, for example, for SSA_1, the selected group of sensing entities (e.g., or group of sensing entities) is noted as SE_SSA_1.
Step 5. For example, based on position and path information of target object 890, Sensing NF 830 may decide sensing operation state of group of sensing entities as active or prepared. Also, for example, based on current position and/or path information of target object 890, SE_SSA_1 may be determined as active and SE_SSA_2 are determined as prepared.
Step 6. For example, Sensing NF 830 sends assigned group of sensing entities information (e.g., SE_SSA_1, SE_SSA_2, or the like) and sensing assistance information to each member of the selected group of sensing entities. Also, for example, for each group of sensing entities, different sensing assistance information will be configured.

Further, for example, Sensing NF 830 may inform each sensing entity of the information of other member entities belonging to the same group of sensing entities.

In addition, for example, Sensing NF 830 also assigns selected group of sensing entities the state of sensing operation as determined at step 5.

For example, SE_SSA_1 may be assigned as active state and SE_SSA_2 is assigned as prepared state.

If the sensing entity is a WTRU, Sensing NF 830 may send assignment and assistance information as a NAS message (e.g., via AMF 840, which serves the sensing entity; e.g., WTRU configuration update). For example, if the sensing entity is a Base Station, Sensing NF 830 may send assignment and assistance information via an N2 procedure and/or message (e.g., via AMF 840).

Moreover, for example, sensing assistance information includes whether sensing measurement report will be transferred via control plane (CP) or via user plane (UP). Furthermore, for example, sensing assistance information also includes time information for transmitting sensing measurement report (e.g., interval between one sensing measurement report and the next sensing measurement report, or the like).

Additionally, for example, when sensing assistance information indicate sensing measurement report over user plane, sensing assistance information include the information for PDU session setup (e.g., DNN, SSC mode, or the like) and server address to access for sending sensing data. Still Further, for example, sensing entity (e.g., WTRU) may setup PDU session for sensing measurement report when it receives sensing assistance information indicating sensing measurement report over UP.

It is noted that step 6 may involve, for example, at least one of one or more sensing entities, one or more of WTRUs 850, one or more of BSs 855, one or more of WTRUs 860, one or more of BSs 865, combinations of the same, or the like.

Step 7. For example, the group of sensing entities assigned as active state start sensing operation as configured by Sensing NF 830.

Also, for example, at least one sensing entity of another group of sensing entities assigned as prepared state (e.g., SE_SSA_2) waits for indication from Sensing NF 830 for state change.

Step 8. For example, at least one sensing entity of a group of sensing entities at active state reports the sensing measurement result to Sensing NF 830.

Also, for example, Sensing NF 830 may calculate the sensing result from sensing measurement result for tracking of target object 890 (e.g., determine whether the target object 890 keep the path as path information, determine the location of target object 890, or the like) and report the sensing result to SANF 820. Further, for example, SANF 820 may report the result to AF 810.

As another embodiment, sensing result may be calculated by some sensing entity. In this case, in step 8, sensing result is reported to Sensing NF 830.

As another embodiment, sensing result may be calculated by SANF 820 or AF 810. In this case, in step 8, Sensing NF 830 report the sensing measurement result to SANF 820.

Step 9. In some examples, path of target object 890 may be updated (e.g., because of climate, traffic condition, or the like). Also, for example, AF 810 may send a sensing service request to update path information. Further, for example, in the sensing service request, information of target object 890, sensing service type indicating tracking, and updated path information (e.g., list of geographic points) may be included.

Step 10. For example, SANF 820 may translate the updated path information of the target object 890 to service area information (e.g., tracking area, sensing service area, or the like) understandable in the network and include that information in the sensing service request to the Sensing NF 830 as updated path information.

Also, for example, SANF 820 may send sensing service request to Sensing NF 830 for tracking of target object 890 with updated path information. Further, for example, the sensing service request may include information of target object 890 and updated path information.

Step 11. For example, Sensing NF 830 may detect path change based on sensing service request at step 10. Also, for example, updated path information is [SSA1, SSA3, SSA4].

As another embodiment, Sensing NF 830 may detect target object 890 deviates from original path provided at step 3. For example, Sensing NF 830 may detect target object 890 deviates from SSA1 and moving into SSA3.
Step 12. For example, Sensing NF 830 may update sensing entities for tracking of target object 890s based on updated path information if received in step 11. Also, for example, sensing entities for tracking at SSA3 may be discovered and selected as member of SE_SSA_3. Further, for example, SE_SSA_3 may be configured sensing assistance information.

As another embodiment, Sensing NF 830 may update sensing entities for tracking of target object 890s when it detects the sensing objects is deviating from original path and is moving toward a neighbor sensing service area. For example, target object 890s deviates from SSA_1 and moves toward to SSA_3, Sensing NF 830 may discover and select sensing entities for tracking at SSA3 and assign the selected sensing entities as SE_SSA_3. Also, for example, SE_SSA_3 may be configured sensing assistance information.
Steps 13-14. For example, when Sensing NF 830 detects target object 890 moves into SSA_3, Sensing NF 830 may indicate SE_SSA_3 to activate sensing operation for tracking of target object 890s.

Also, for example, Sensing NF 830 may indicate SE_SSA_1 and SE_SSA_2 into prepared state or release state.

It is noted that step 14 may involve, for example, at least one of one or more sensing entities, one or more of WTRUs 850, one or more of BSs 855, one or more of WTRUs 860, one or more of BSs 865, one or more of WTRUs 870, one or more of BSs 875, combinations of the same, or the like.
Step 15. For example, based on the indication, SE_SSA_3 transition into active state and start sensing operation for tracking target object 890
Step 16. For example, at least one sensing entity of a group of sensing entities at active state reports the sensing measurement result to Sensing NF 830.

Also, for example, Sensing NF 830 may calculate the sensing result from sensing measurement result for tracking of target object 890 (e.g., determine whether the target object 890 keep the path as path information, determine the location of target object 890, or the like) and report the sensing result to SANF 820. Further, for example, SANF 820 may report the result to AF 810.

As another embodiment, sensing result may be calculated by some sensing entity. In this case, in step 15, sensing result is reported to Sensing NF 830.

As another embodiment, sensing result may be calculated by SANF 820 or AF 810. In this case, in step 15, Sensing NF 830 report the sensing measurement result to SANF 820.

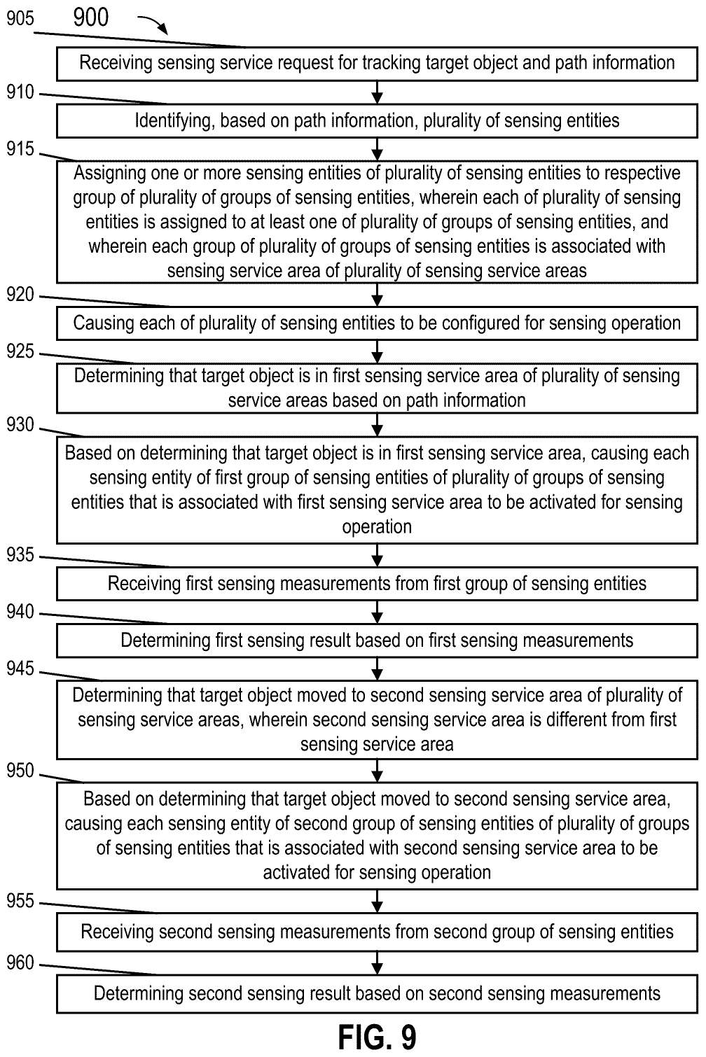

In certain representative embodiments, as shown, for example, in FIG. 9, a method 900 performed by a wireless network for sensing handover comprises one or more steps. For example, the method 900 comprises receiving (e.g., at 905) a sensing service request for tracking a target object (e.g., 690) and path information. Additionally, for example, based on the path information, the network identifies (e.g., at 910) a plurality of sensing entities (e.g., WTRUs 650, BSs 655, WTRUs 660, BSs 665, or the like). Moreover, for example, the network assigns (e.g., at 915) one or more sensing entities to a respective group of a plurality of groups of sensing entities. In addition, for example, each sensing entity is assigned (e.g., at 915) to at least one group, and each group is associated with a specific sensing service area (e.g., SSA #1, SSA #2, or the like). Furthermore, for example, the network configures (e.g., at 920) each sensing entity for sensing operation. For example, the network determines (e.g., at 925) that the target object (e.g., 690) is in a first sensing service area (e.g., SSA #1) based on the path information. Based on this determination, for example, the network activates (e.g., at 930) each sensing entity (e.g., WTRUs 650, BSs 655, or the like) in the first group associated with the first sensing service area (e.g., SSA #1) for sensing operation. Additionally, for example, the network receives (e.g., at 935) first sensing measurements from the first group of sensing entities (e.g., WTRUs 650, BSs 655, or the like). Moreover, for example, the network determines (e.g., at 940) a first sensing result based on these measurements. Further, for example, the network determines (e.g., at 945) that the target object (e.g., 690) has moved to a second sensing service area (e.g., SSA #2), which is different from the first. Based on this new determination, for example, the network activates (e.g., at 950) each sensing entity (e.g., WTRUs 660, BSs 665, or the like) in the second group associated with the second sensing service area (e.g., SSA #2) for sensing operation. Additionally, for example, the network receives (e.g., at 955) second sensing measurements from the second group of sensing entities (e.g., WTRUs 660, BSs 665, or the like). In addition, for example, the network determines (e.g., at 960) a second sensing result based on these measurements.

The method 900 also includes, for example, updating the state of each sensing entity when activating them for sensing operation. Also, for example, the network involves configuring each sensing entity with sensing assistance information. Additionally, for example, at least one sensing entity in the first or second group can be a wireless transmit/receive unit (WTRU) (e.g., one of WTRUs 650, WTRUs 660, or the like). Moreover, for example, at least one sensing entity in the first or second group can be a base station (e.g., one of BSs 655, BSs 665, or the like). Furthermore, for example, the method 900 comprises performing an operation based on at least one of the first sensing result or the second sensing result. Additionally, for example, the method 900 may include one or more of steps 1-12 of FIG. 6.

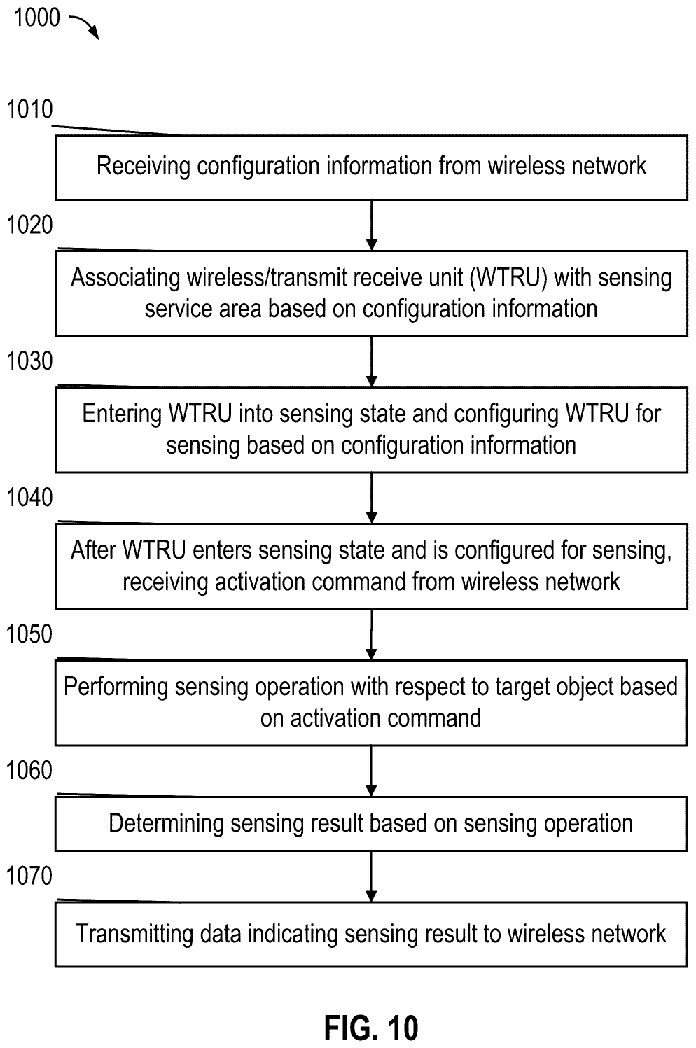

In certain representative embodiments, as shown, for example, in FIG. 10, a method 1000 for sensing handover between sensing entities (e.g., WTRUs 750, BSs 755, WTRUs 760, BSs 765, or the like) is provided. The method 1000 may be performed by a first sensing entity (e.g., one of WTRUs 750, BSs 755, or the like) in communication with a wireless network and a second sensing entity (e.g., one of WTRUs 760, BSs 765, or the like). The method 1000 may be performed by a WTRU (e.g., one of WTRUs 750 and WTRUs 760, or the like) in communication with the wireless network. For example, the method 1000 comprises receiving (e.g., at 1010) configuration information from the wireless network. Also, for example, the method 1000 comprises associating (e.g., at 1020) the WTRU with a sensing service area (e.g., SSA #1) based on the configuration information. Further, for example, the method 1000 comprises entering (e.g., at 1030) the WTRU into a sensing state and configuring the WTRU for sensing based on the configuration information. In addition, for example, the method 1000 comprises after the WTRU enters the sensing state and is configured for sensing, receiving (e.g., at 1040) an activation command from the wireless network. Moreover, for example, the method 1000 comprises performing (e.g., at 1050) a sensing operation with respect to a target object (e.g., 790) based on the activation command. Furthermore, for example, the method 1000 comprises determining (e.g., at 1060) a sensing result based on the sensing operation. Additionally, for example, the method 1000 comprises transmitting (e.g., at 1070) data indicating the sensing result to the wireless network. Still further, for example, the method 1000 comprises performing an operation based on at least one of the first sensing result or the second sensing result. Even further, for example, the method 1000 may include one or more of steps 1-13 of FIG. 7.

For example, the first sensing entity receives information from the wireless network, which causes the first sensing entity to be associated with a first sensing service area (e.g., SSA #1) and perform a sensing operation. Additionally, the first sensing entity determines a sensing result based on the sensing operation. Moreover, the first sensing entity detects movement of a target object (e.g., 790) to a second sensing service area (e.g., SSA #2) based on the sensing result. Furthermore, the first sensing entity causes the activation of a sensing operation at the second sensing entity at the second sensing service area (e.g., SSA #2) based on the detected movement of the target object (e.g., 790) to the second sensing service area (e.g., SSA #2). Furthermore, for example, the method may include one or more of steps 1-13 of FIG. 7.

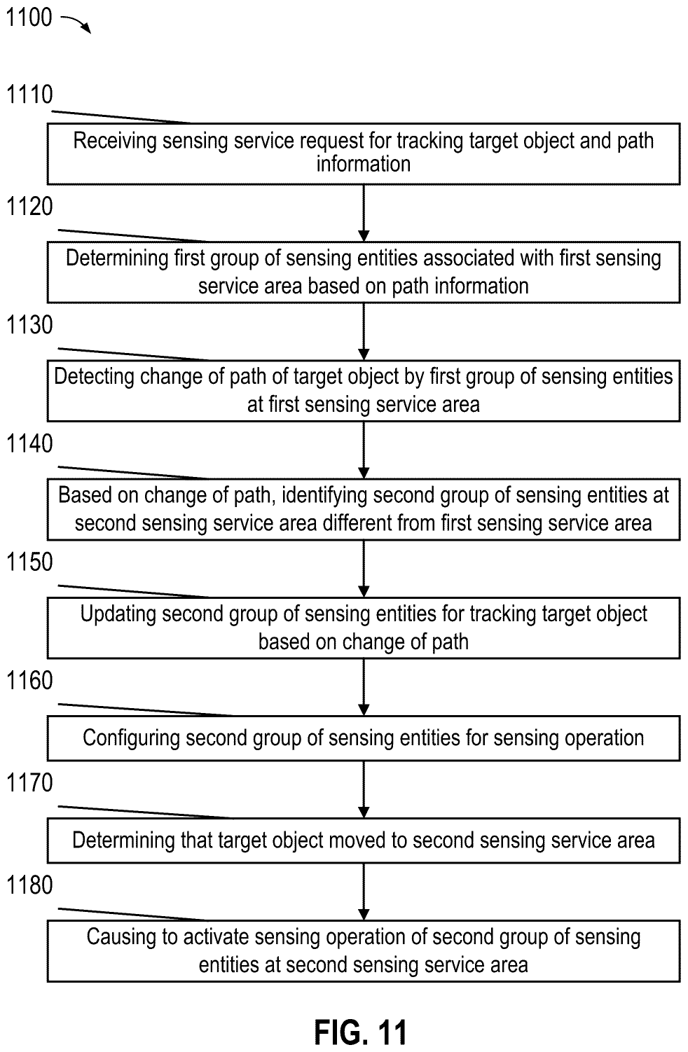

In certain representative embodiments, as shown, for example, in FIG. 11, a method 1100 for sensing handover with an updated sensing path is provided. In certain representative embodiments, a method 1100 is performed by a wireless network in communication with a first group of sensing entities (e.g., WTRUs 850, BSs 855, or the like) and a second group of sensing entities(e.g., WTRUs 860, BSs 865, or the like). For example, the method 1100 comprises receiving (e.g., at 1110) a sensing service request for tracking a target object (e.g., 890) and path information. Additionally, the network determines (e.g., at 1120) the first group of sensing entities associated with a first sensing service area (e.g., SSA #1) based on the path information. Moreover, the network detects (e.g., at 1130) a change of a path of the target object (e.g., 890) by the first group of sensing entities at the first sensing service area. Furthermore, based on the change of the path, the network identifies (e.g., at 1140) the second group of sensing entities at a second sensing service area (e.g., SSA #2) different from the first sensing service area. Additionally, the network updates (e.g., at 1150) the second group of sensing entities for tracking the target object (e.g., 890) based on the change of the path. Moreover, the network configures (e.g., at 1160) the second group of sensing entities for sensing operation. Furthermore, the network determines (e.g., at 1170) that the target object (e.g., 890) moved to the second sensing service area. Finally, the network causes (e.g., at 1180) the activation of the sensing operation of the second group of sensing entities at the second sensing service area. Furthermore, for example, the method 1100 may include one or more of steps 1-16 of FIG. 8.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless network, the method comprising:
receiving a sensing service request for tracking a target object and path information;
identifying, based on the path information, a plurality of sensing entities;
assigning one or more sensing entities of the plurality of sensing entities to a respective group of a plurality of groups of sensing entities, wherein each of the plurality of sensing entities is assigned to at least one of the plurality of groups of sensing entities, and wherein each group of the plurality of groups of sensing entities is associated with a sensing service area of a plurality of sensing service areas;
causing each of the plurality of sensing entities to be configured for sensing operation;
determining that the target object is in a first sensing service area of the plurality of sensing service areas based on the path information;
based on determining that the target object is in the first sensing service area, causing each sensing entity of a first group of sensing entities of the plurality of groups of sensing entities that is associated with the first sensing service area to be activated for sensing operation;
receiving first sensing measurements from the first group of sensing entities;
determining a first sensing result based on the first sensing measurements;
determining that the target object moved to a second sensing service area of the plurality of sensing service areas, wherein the second sensing service area is different from the first sensing service area;
based on determining that the target object moved to the second sensing service area, causing each sensing entity of a second group of sensing entities of the plurality of groups of sensing entities that is associated with the second sensing service area to be activated for sensing operation;
receiving second sensing measurements from the second group of sensing entities; and
determining a second sensing result based on the second sensing measurements.

2. The method of claim 1, wherein steps of the method are performed by at least one of the following functions of the wireless network: an application function, a sensing operation management function, a sensing assistance function, or access and mobility management functions.

3. The method of claim 1, further comprising based on determining that the target object moved to the second sensing service area, causing each sensing entity of the first group of sensing entities to be placed in a release state.

4. The method of claim 1, wherein causing each of the plurality of sensing entities to be configured for sensing operation comprises configuring each of the plurality of sensing entities based on sensing assistance information.

5. The method of claim 4, wherein the sensing assistance information comprises information indicating at least one of a sensing mechanism to be used for sensing, a waveform of a sensing signal, a resource pool, or a period of time for performing sensing measurements.

6. The method of claim 1, wherein at least one sensing entity of the plurality of sensing entities comprises a respective wireless transmit/receive unit (WTRU).

7. The method of claim 1, wherein at least one sensing entity of the plurality of sensing entities comprises a respective base station.

8. The method of claim 1, further comprising performing an operation based on at least one of the first sensing result or the second sensing result.

9. A system implementing one or more network functions of a core network of a wireless network, wherein the system comprises one or more processors configured to:
receive a sensing service request for tracking a target object and path information;
identify, based on the path information, a plurality of sensing entities;
assign one or more sensing entities of the plurality of sensing entities to a respective group of a plurality of groups of sensing entities, wherein each of the plurality of sensing entities is assigned to at least one of the plurality of groups of sensing entities, and wherein each group of the plurality of groups of sensing entities is associated with a sensing service area of a plurality of sensing service areas;
cause each of the plurality of sensing entities to be configured for sensing operation;
determine that the target object is in a first sensing service area of the plurality of sensing service areas based on the path information;
based on determining that the target object is in the first sensing service area, cause each sensing entity of a first group of sensing entities of the plurality of groups of sensing entities that is associated with the first sensing service area to be activated for sensing operation;
receive first sensing measurements from the first group of sensing entities;
determine a first sensing result based on the first sensing measurements;
determine that the target object moved to a second sensing service area of the plurality of sensing service areas, wherein the second sensing service area is different from the first sensing service area;
based on determining that the target object moved to the second sensing service area, cause each sensing entity of a second group of sensing entities of the plurality of groups of sensing entities that is associated with the second sensing service area to be activated for sensing operation;
receive second sensing measurements from the second group of sensing entities; and
determine a second sensing result based on the second sensing measurements.

10. The system of claim 9, wherein the one or more network functions comprise: an application function, a sensing operation management function, a sensing assistance function, or access and mobility management functions.

11. The system of claim 9, wherein the one or more processors are further configured to, based on determining that the target object moved to the second sensing service area, cause each sensing entity of the first group of sensing entities to be placed in a release state.

12. The system of claim 9, wherein the one or more processors are further configured to cause each of the plurality of sensing entities to be configured for sensing operation is configured to configure each of the plurality of sensing entities based on sensing assistance information.

13. The system of claim 12, wherein the sensing assistance information comprises information indicating at least one of a sensing mechanism to be used for sensing, a waveform of a sensing signal, a resource pool, or a period of time for performing sensing measurements.

14. The system of claim 9, wherein at least one sensing entity of the plurality of sensing entities comprises a respective wireless transmit/receive unit (WTRU).

15. The system of claim 9, wherein at least one sensing entity of the plurality of sensing entities comprises a respective base station.

16. The system of claim 9, wherein the one or more processors is further configured to perform an operation based on at least one of the first sensing result or the second sensing result.

17. A method performed by a wireless transmit/receive unit (WTRU) in communication with a wireless network, the method comprising:
receiving configuration information from the wireless network;
associating the WTRU with a sensing service area based on the configuration information;
entering the WTRU into a sensing state and configuring the WTRU for sensing based on the configuration information;
after the WTRU enters the sensing state and is configured for sensing, receiving an activation command from the wireless network;
performing a sensing operation with respect to a target object based on the activation command;
determining a sensing result based on the sensing operation; and
transmitting data indicating the sensing result to the wireless network.

18. The method of claim 17, further comprising:
receiving, from the wireless network, an indication to enter a release state; and
entering the release state based on the indication to enter the release state.

19. The method of claim 17, wherein the configuration information comprises sensing assistance information.

20. The method of claim 19, wherein the sensing assistance information comprises information indicating at least one of a sensing mechanism to be used for sensing, a waveform of a sensing signal, a resource pool, or a period of time for performing sensing measurements.
